(19) United States
(12) Patent Application Publication
(10) Pub. No.: US 2013/0198272 A1
(43) Pub. Date: Aug. 1, 2013

(54) OPERATION LOG STORAGE SYSTEM, DEVICE, AND PROGRAM

(71) Applicants: Tomotaka Shionoya, Yokohama (JP); Hiromitsu Nakagawa, Yokohama (JP); Tomohiro Nakamura, Hachioji (JP); Tatsuya Sato, Fujisawa (JP)

(72) Inventors: Tomotaka Shionoya, Yokohama (JP); Hiromitsu Nakagawa, Yokohama (JP); Tomohiro Nakamura, Hachioji (JP); Tatsuya Sato, Fujisawa (JP)

(21) Appl. No.: 13/820,227

(22) PCT Filed: Feb. 10, 2011
(86) PCT No.: PCT/JP2011/052878

§ 371 Date: Apr. 15, 2013

(30) Foreign Application Priority Data
Oct. 14, 2010 (JP) 2010-231771

(51) Int. Cl. H04L 29/06

(52) U.S. Cl. CPC H04L 67/42
USPC 709/203

(57) ABSTRACT

The objective of the present invention is to record the state of an application to be logged of a client at a server and to evaluate the code efficiency for each change of state so as to consistently achieve optimal code efficiency. The operational log record system (1) of the present invention is configured with a client apparatus (3) and a server apparatus (2) for storing the operational log thereof, wherein a memory device (14) of the server apparatus and a storage device (16), via a communication interface (10), store a code table generation program (104) for generating a code table on the basis of an operational log transmitted from the client apparatus (3), a code function group (500) for coding the operational log, and the program state upon the client apparatus which has been estimated on the basis of the operational log. The memory device (14) of the client apparatus (3) stores the code table which has been transmitted from the server apparatus (2), an application group to be logged (110), and an operational log acquisition program (108) for acquiring the operational log. The server apparatus (2) stores away the operational log which has been received from the client apparatus (3) in a sequential storage device (16) as the operational log.

### TECHNICAL FIELD

The present invention relates to a system for acquiring and storing an operational log of an application, and more particularly, to a technology for reducing the communication traffic between devices constituting a system.

### BACKGROUND ART

In recent years, communication between devices through a network has been widely used and collaboration between devices using communication has been common. A typical example is a Web application. This is an application form realized by processing an application, which is provided by a server apparatus and readable by a browser device, on the client side, and by transmitting data from the client apparatus to the server apparatus as needed.

In the Web application, an application runs on a variety of client apparatuses, so that the usability and performance of the application may differ in each user environment. Thus, there is an increasing demand for the evaluation of the availability of the Web application from the operation or event performed on the Web application on the client apparatus.

Under these circumstances, there has been developed an application in which the operation of the client apparatus is transmitted to the server apparatus at regular intervals and the operational log is stored in the Web application of the server apparatus. However, the introduction of this application increases the network load, resulting in a reduction in the original response performance of the Web application.

The simplest way to address such a problem is to compress the operational log using a code function such as zip compression. However, in the case of coding for compression, in general, the object to be compressed has a large number of the same code string. Thus, the code efficiency without overlapping (the ratio of the code length before coding and the code length after coding) may not increase. In other words, this requires the assumption that the code length of the operational log is sufficiently long. In order to achieve this, the client apparatus is forced to store an enormous amount of operational logs, although only temporarily.

In order to address the problem of network load reduction with low client load, Patent Literature 1 describes a technique for reducing the network load or the process load of the other device by preprocessing information to be transmitted by the other device.

### CITATION LIST

### Patent Literature

Patent Literature 1: Japanese Patent Application Laid-open Publication No. 2006-259811

### SUMMARY OF INVENTION

### Technical Problem

The technique described in Patent Literature 1 achieves transmission of information effective for the pre-processing due to the fact that the process performed by the other device is consistently the same. In general, the Web application includes a plurality of pages and the process performed in each page is largely different. For this reason, in the method described in Patent Literature 1, effective pre-processing information may not be generated, so that the network load reduction effect may not be obtained. In some cases, the load may even increase.

The present invention has been made in light of the above problems, and an object thereof is to provide an operational log record system, device, and program that can acquire the operational log of the operation performed by the other device with low network load, even if the particular process is wide-ranging.

### Solution to Problem

In order to achieve the above object, according to an aspect of the present invention, there is provided an operational log record system including a client apparatus for acquiring an operational log, and a server apparatus for storing the operational log. Each of the client apparatus and the server apparatus includes a storage unit for storing a program and data, a processing unit for processing the program, and a communication interface. The storage unit of the server apparatus stores an operational log transmitted from the client apparatus through the communication interface, a plurality of code functions for coding the operational log, and a code table generation program for estimating the state of the program processed on the client apparatus based on the received operational log and for generating a code table based on the estimated program state. The storage unit of the client apparatus stores the code table transmitted from the server apparatus, the target application as a program, an operational log acquisition program for acquiring the operational log for the target application, and a code conversion program for coding the operational log acquired by the operational log acquisition program by using the code table received from the server apparatus. The processing unit of the client apparatus transmits the operational log that is coded by the code conversion program. The processing unit of the server apparatus inversely converts the received coded operational log and sequentially stores in the storage unit of the server apparatus.

Further, in order to achieve the above object, according to another aspect of the present invention, there is provided a server apparatus for collecting and storing the operational log acquired by the client apparatus. The server apparatus includes a storage unit for storing a program and data, as well as a communication interface. The storage unit stores an operational log transmitted from the client apparatus, a plurality of code functions for coding the operational log, and a code table generation program for estimating the state of the program to be processed on the client apparatus based on the received operational log and for generating a code table based on the estimated program state, and an application which is a target program for collecting the operational log by the client apparatus. The processing unit executes the code table generation program to estimate the state of the program to be processed on the client apparatus based on the received operational log, and generate a code table based on the estimated program state. Then, the processing unit transmits the generated code table to the client apparatus.

Further, in order to achieve the above object, according to still another aspect of the present invention, there is provided an operational log storage program executed by a processing unit of a server apparatus. The server apparatus includes a storage unit for storing a program and data as well as the processing unit for processing the program, to collect and store the received operational log of a program acquired by a client apparatus. The operational log storage program allows the processing unit to receive and store an operational log transmitted from the client apparatus through a communication interface, estimate the state of a program to be processed on the client apparatus based on the received operational log, generate a code table based on the estimated program state, and transmit the generated code table to the client apparatus.

In other words, in order to achieve the above object, according to a preferred embodiment of the present invention, there is provided an operational log record system including a server apparatus for storing an operational log, and a client apparatus for acquiring the operational log. The server apparatus includes a memory device for storing a program or data, a processor device for loading and processing the program stored in the memory device, and a communication interface for transmitting and receiving information to and from the client apparatus. The memory device of the server apparatus has an operational log storage area for storing the operational log transmitted from the client apparatus, and a statistics record area for recording the statistical information of the operational log and the code function thereof. The memory device of the server apparatus stores a program state estimation program for estimating the state of the program processed on the client apparatus based on the operational log, a code efficiency evaluation program for evaluating the code efficiency of the operational log transmitted from the client apparatus, a code table generation program for generating a code table that is estimated to be of the highest efficiency based on the program state estimated by the program state estimation program with respect to the operational log, an inverse code conversion program for inversely converting the coded and transmitted operational log, and two or more code functions for coding the particular operational log. The client apparatus includes a memory device for storing a program or data, a processor device for loading and processing the program stored in the memory device, an output device for outputting the output result of the program, an input device for operating the program, and a communication interface for transmitting and receiving information to and from the server apparatus. The memory device of the client apparatus includes an operational log area for temporarily storing the operational log, and a code table area for storing the code table generated by the code table generation program that is transmitted from the server apparatus. Further, the memory device of the client apparatus stores a target application for acquiring one or more operations, an operational log acquisition program for acquiring the operation for the target application, and a code conversion program for coding the operational log acquired by the operational log acquisition program by using the code function specified by the server apparatus.

### Advantageous Effects of Invention

According to an aspect of the present invention, it is possible to collect the application operational log at high efficiency with low network load and also with low client load.

### BRIEF DESCRIPTION OF DRAWINGS

FIG. 1 is a block diagram of an operational log record system according to a first embodiment.

FIG. 2 shows an example of the operational log storage flow according to the first embodiment.

FIG. 3 shows an example of the configuration of an optimal code generation mechanism according to the first embodiment.

FIG. 4 is an example of a flowchart of the code efficiency evaluation step according to the first embodiment.

FIG. 5 is an example of a flowchart of the state transition detection step according to the first embodiment.

FIG. 6 is an example of a code table according to the first embodiment.

FIG. 7 is an example of a code function according to the first embodiment.

FIG. 8 is another example of the code function according to the first embodiment.

FIG. 9 is a sequence diagram showing an example of the operation of the operational log record system according to the first embodiment.

FIG. 10 shows an example of the configuration of an operational log record system according to a second embodiment.

FIG. 11 is an example of an operational log storage flow according to the second embodiment.

FIG. 12 is a sequence diagram showing an example of the operation of the operational log record system according to the second embodiment.

### DESCRIPTION OF EMBODIMENTS

In this specification, the same devices are denoted by the same reference numerals. Further, operational log means a log of an overall event generated on an application, including one or both of the following histories: the operation history of the user operation, and the event history which is the change in the state of the application. In addition, in this specification, the database is a data management function for managing a table of a set of recodes, which is a data group containing one or more data arranged in order.

### First Embodiment

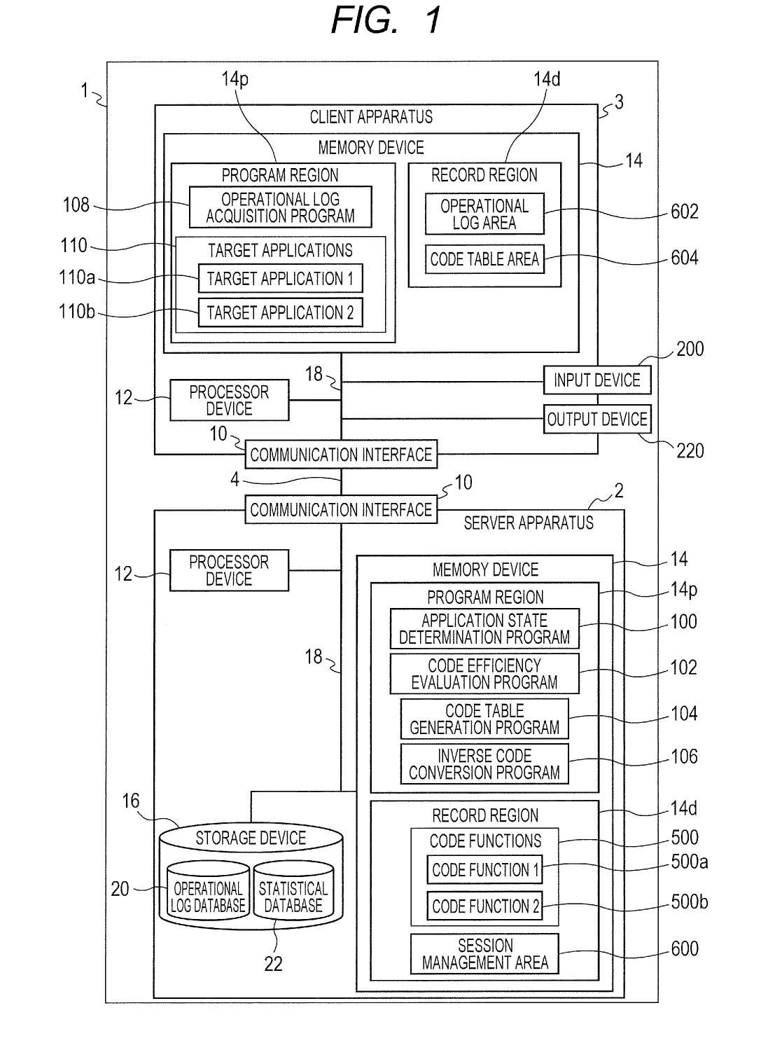

FIG. 1 shows an example of the configuration of an operational log record system according to a first embodiment. In this figure, an operational log record system 1 includes a server apparatus 2 for storing an operational log, and a client apparatus 3 for storing an operational log acquisition target application 110 and processing the operational log acquisition target application 110. Then, these devices are connected by a network connectivity 4 to each other. The network connectivity 4 can be realized by a physical cable or by using a wireless technology. It is also possible to realize the network connectivity 4 by using a network such as a local area network (LAN) or a wide area network (WAN). Further, both the client apparatus 3 and the server apparatus 2 may not necessarily be a single unit. A plurality of client apparatuses 3 and server apparatuses 2 may be provided for the purpose of load dispersion or other purposes.

In this embodiment, the server apparatus 2 functions as a device for semi-permanently recording the operational log on the target application 110 running on the client apparatus 3, or for extracting and semi-permanently recording the statistics of the operational log. The server apparatus 2 has a configuration of a normal computer, including a communication interface 10, a processor device 12 which is a processing unit, a memory device 14 which is a storage unit, a storage device 16, and a bus 18 for connecting these devices.

The communication interface 10 of the server 2 is a device for transmitting commands and data to the other device connected through the network connectivity 4, or for receiving commands and data from the other device. The communication interface 10 may not necessarily be a single unit. If the types of the network connectivity 4 are wide-ranging, a plurality of communication interfaces 10 may be provided according to the types of the network connectivity 4. It is also possible to connect a plurality of communication interfaces 10 to the same network connectivity 4 in order provide dedicated communication paths and the like. In the following description, if not otherwise specified in transmission and reception of data between the server apparatus 2 and the client apparatus 3, the transmission and reception of data is implicitly performed through the communication interface 10 and the network connectivity 4.

The processor device 12 is a central processing unit (CPU) and the like that executes the program stored in the memory device 14, or reads and writes data from and to the memory device 14 and the storage device 16. The server apparatus 2 may be provided with a plurality of processor devices 12. Hereinafter, the operation that the processor device 12 reads various programs from the memory device and processes the programs, will be expressed as “executing programs”.

The memory device 14 is a device for storing processing means used by the server apparatus 2 and for storing information. In general, the memory device 14 is a fast read/write memory device 14 including a non-volatile memory such as a dynamic RAM (DRAM). If the latency of the application allows, it is possible to use high capacity recording media such as a hard disk drive (HDD) and a solid state drive (SDD), or possible to use a write once media such as a CD-Recordable (CD-R). Further, the memory device 14 may not necessarily be a single unit. A plurality of memory devices 14 can be arranged in parallel like Redundant Arrays of Inexpensive Disks (RTAID), or can be connected in series like Just a Bunch Of Disks (JBOD).

The memory device 14 is divided into two areas: a program region 14p and a record region 14d. However, it is to be noted that these areas may not be divided by a distinct borderline on the logical memory space, and that this area division is for convenience only.

The program region 14p stores an application state determination program 100 for determining the state of the operational log acquisition target application 110 running on the client apparatus 3 based on the operational log transmitted from the client apparatus 3, a code efficiency evaluation program 102 for evaluating the code efficiency of the operational log, a code table generation program 104 for generating a code table by using an specified code function 500 as well as the occurrence rate of the sequence, and an inverse code conversion program 106 for inversely converting the coded operational log based on the code table.

These programs are not necessarily constantly stored in the memory device 14, and may be loaded from the storage device 16 or from another device connected through the network connectivity 4 at the time of execution. Further, if it is configured to have a complied program, the programs can be converted into native code readable by the processor device 12 from the source file, and provided in the memory device 14 at the time of execution.

The record region 14d stores two or more code functions 500. Further, a session management area 600 is located in the record region 14d to manage the current state in the operational log acquisition session of the target application 110 as well as the code table. The code functions 500, just as the other programs, can be loaded from the storage device 16 or from another device through the network connectivity 4 as needed. If it is configured to have a dedicated conversion program, the code functions can be actively converted into native code from other languages when they are referred to by the other program.

The session management area 600 of the record region 14d is an area for managing the state from the start of a certain target application 110 to the end of the target application 110. The session management area 600 manages the state ID of the target application 110 used in the session together with the code table. The following description will assume that the reference of the application current state and the code table in the server apparatus 2 is done by implicitly querying the session management area 600.

The application state determination program 100 is a program that takes an operational log as an input, outputting the before state and the after state upon detecting an event showing the state change included in the operational log.

The code efficiency evaluation program 102 is a program that takes an operational log as an input, having a function of updating the statistics of the operational log on a statistical database 22, a function of evaluating the code function 500 with the highest code efficiency of the code functions 500 included in the server apparatus 2 based on the updated statistics, and a function of updating the code function 500 determined by the code efficiency evaluation function on the statistical database 22.

The code table generation program 104 is a program that takes the statistics of the operational log and the code functions 500 as an input, outputting the code table which is a pair of an operation or operations in order and the corresponding code. Hereinafter the operations in order will be referred to as a sequence.

The inverse code conversion program 106 is a program that takes the coded operational log and the code table as an input, outputting the operational log that is inversely converted, namely, the decoded operational log. Hereinafter the coded operational log will be referred to as the coded log.

The storage device 16 is a device to create a database of the operational log transmitted from the client apparatus 3 and the statistics extracted from the operational log, and semi-permanently store the database. In this specification, the database is a data management function for managing the table which is a set of records (a data group containing one or more data arranged in order). The data management function includes four functions of adding, deleting, extracting, and compiling records for a particular table.

In general, the storage device 16 means a large-scale nonvolatile recording media such as HDD and SSD. However, it is possible to use a high-speed nonvolatile memory such as DRAM if semi-permanent storage allowed by the application is possible. Further, if the function of the database can be realized within the time required by the application, it is also possible to use updatable optical recording media such as Blu-Ray Disk (BD), or use a write-once media, such as CD-R, as long as the database can be managed. Still further, if the memory device 14 has enough capacity, it is possible to provide a database area within the memory device 14. In this case, a database of the statics of the operational log can be made in the database area. Alternatively, an external storage device 16 connected by the communication interface 10 can also be used.

Further, the storage device 16, just like the memory device 14, is not necessarily a single unit. A plurality of storage devices 16 may be arranged in parallel or in series.

The bus 18 is a device for achieving transmission and reception of data between the devices of the system. The bus 18 is configured by connecting an internal bus such as a CPU bus and an address bus, and an extension bus such as a serial ATA and a PCI express. This is generally for a wired bus 18. However, a wireless bus 18 can also be used for simplification of the lines. The following description will assume that the transmission and reception is implicitly achieved through the bus 18 in the communication between devices included in the server apparatus 2 or in the client apparatus 3, if not otherwise specified.

The client apparatus 3 is a device in which the application for acquiring the operational log runs. The client apparatus 3 has a normal computer configuration, including the communication interface 10, the processor device 12, the memory device 14, the input device 200, and the output device 220. The communication interface 10, the processor device 12 which is a processing unit, and the memory device 14 which is a storage unit are the same devices as those of the server apparatus 2.

The input device 200 is a device for converting the input of the user to a physical signal such as an electrical signal readable by the device. Examples of the input device 200 are a keyboard, a mouse, a microphone, and a sensor. The input device 200 is not necessarily attached to the device. The input device 200 can be connected through the network connectivity 4. The output device 220 is a device for converting the output of the device to information such as an image or sound that can be understood by humans. Examples of the output device 220 are a display, a printer, a plotter, a speaker, and a motor. Similarly, the output device 220 is not necessarily attached to the device and can be connected through the network connectivity 4.

In the program region 14p on the memory device 14, the following programs are located: a program of the target application 110 for acquiring the operational log, and an operational log acquisition program 108 for monitoring the target application 110, acquiring and coding the operational log of the application, and transmitting the coded log to the server apparatus 2. One or a plurality of programs can be provided for the target application 110. Further, these programs are not necessarily constantly stored in the memory device 14, just like the programs in the server apparatus 3.

In the record region 14d on the memory device 14, the following areas are located: the operational log area 602 in which the operational log acquired from the target application 110 is stored, and the code table area 604 in which the code table for each target application 110 received from the server apparatus 2 is stored.

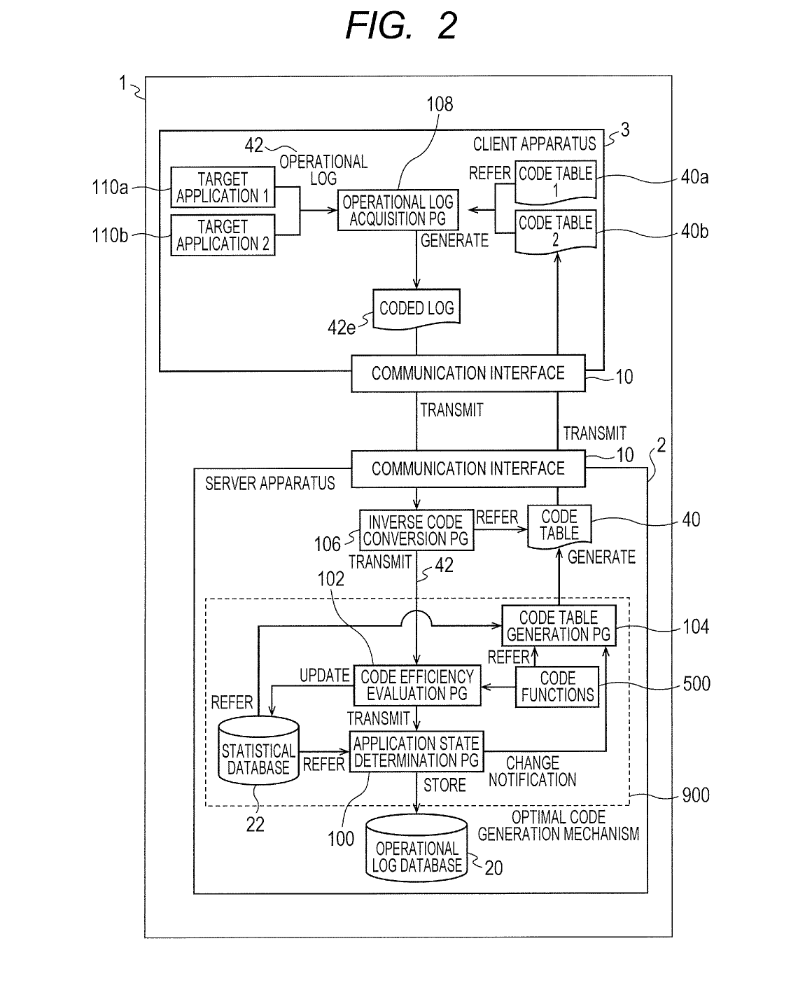

The above is the configuration of the operational log record system according to the first embodiment. Now, the path from the generation of the operational log to the storage thereof will be described with reference to FIG. 2, in order to show the relationship between these devices. FIG. 2 is an example of the path from the acquisition of the operational log to the storage thereof in the operational log record system in this embodiment. Note that in the drawings of this specification, PG represents the program.

First, in FIG. 2, the operation in each target application 110 on the client apparatus 3 is acquired by the operational log acquisition program 108. The acquired operational log 42 is temporarily stored in the operational log area 604. At the time when the operational log 42 is accumulated, the operational log acquisition program 108 codes the operational log 42 by referring to the code table corresponding to each application that is stored in the code table area 604. In this way, the operational log acquisition program 108 generates a coded log 42e. Then, the operation program 108 deletes the operational log 42 that has been coded, from the operational log area 602. The accumulation amount of the operational log 42 at the time of the start of this coding is the value determined by the setting of the operational log acquisition program 108. In the configuration in which the client apparatus 3 does not allow the temporal storage of the operational log 52, the coding is performed for each operational log 42. At the time of the completion of the coding, the operational log acquisition program 108 transmits the coded log 42e to the server apparatus 2 through the communication interface 10.

The coded log 42e of the operational log, which is transmitted to the server apparatus 2, is first received by the inverse code conversion program 106 of the server apparatus 2. The inverse code conversion program 106 inversely converts the coded log 42e by referring to the code table 40. The code table 40 is the same code table that is transmitted to the client apparatus 3. The management for each session is achieved by the code table generation program 104 using the session management area 600. The inverse code conversion program 106 transmits the inversely converted operational log 42 to an optimal code generation mechanism 900.

The optimal code generation mechanism 900 is a process mechanism for determining the optimal code function 500, generating the code table 40, and recording the operational log 42 and the statistics thereof. The code efficiency evaluation program 102 of the optimal code generation mechanism 900 evaluates the code efficiency when each of the code functions 500 is applied to the received operational log 42. Further, the code efficiency evaluation program 102 of the optimal code generation mechanism 900 extracts the statistics from the operational log 42, and updates corresponding tables stored in the statistical database 22. Then, the code efficiency evaluation program 102 transmits the operational log 42 to the application state determination program 100.

The application state determination program 100 determines the change in the application state from the event history included in the received operational log 42. If there is a change in the application state, the application state determination program 100 extracts the suitable code function 500 from the statistical database 22, and notifies the code table generation program 104 of the extracted code function 500.

Upon receiving the notification, the code table generation program 104 selects the appropriate code function 500 from the code functions 500 if needed, regenerates the code table 40 and transmits to the client apparatus 3. The code table 40 received by the client apparatus 3 is updated by the operational log acquisition program 108 in the code table area 604. Finally, the application state determination program 100 stores the operational log 42 in the operational log database 20. Thus, the storage of the operational log 42 is completed.

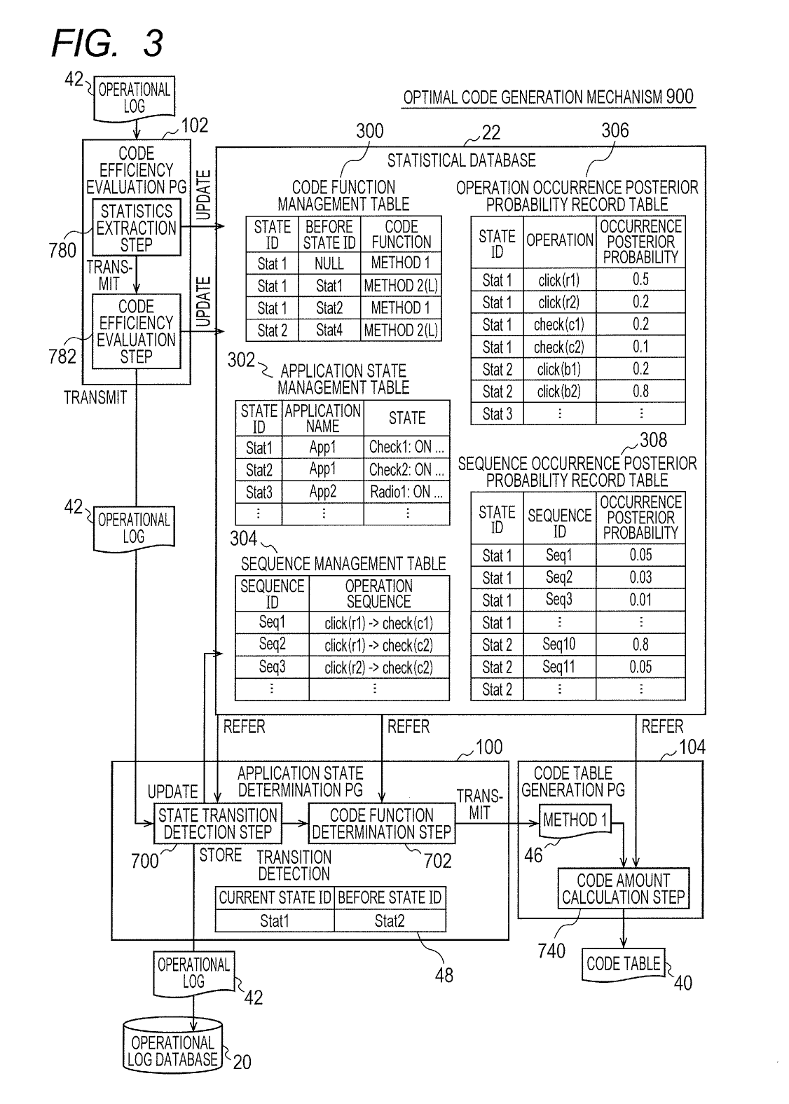

The above is the general process from the generation of the operational log 42 to the storage thereof. Hereinafter, the process in the optimal code generation mechanism 900 in this embodiment will be described in detail with reference to FIGS. 3 to 8.

FIG. 3 is a specific example of the implementation of the optimal code generation mechanism 900. The details of the devices will be described below.

### <Operation of the Code Efficiency Evaluation Program 102>

The code efficiency evaluation program 102 receives the operational log 42 transmitted from the inverse code conversion program 106. Then, the code efficiency evaluation program 102 extracts the statistics of the operational log 42 in the statistics extraction step 780. Then, the code efficiency evaluation program 102 updates the records corresponding to the current state in an operation occurrence posterior probability record table 306, a sequence occurrence posterior probability record table 308, and a sequence management table 304 in the statistical database 22, respectively. Further, in the code efficiency evaluation step 782, the code efficiency evaluation program 102 determines the code function 500 by which the statistics updated by the optimal code efficiency can be coded, of the code functions 500 included in the server apparatus 2.

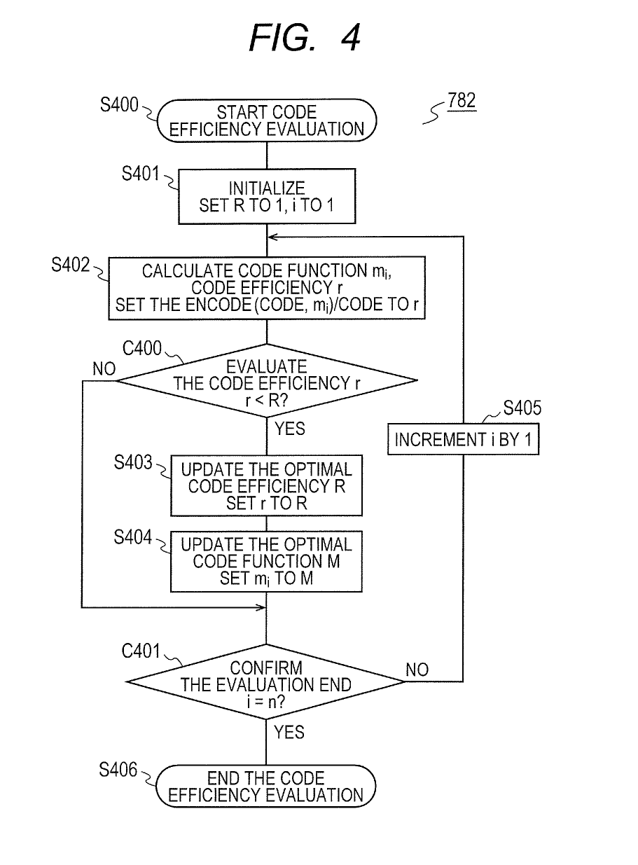

FIG. 4 is an implementation example of the code efficiency evaluation step 782 of the operational log 42. Steps S401 to S406 will be sequentially described. First, the code efficiency evaluation program 102 initializes the optimal code efficiency R by 1 and the counter i by 1, respectively (S401). The counter i is a counter used in referring to each of the code functions 500 included in the server apparatus 2. The domain is from 1 to n.

Then, the code efficiency evaluation program 102 codes the operational log 42 received by the code function 500 included in the server apparatus 2, and divides the code length by the code length of the original operational log 42 (S402). The division result is the code efficiency r by the code function 500. The code efficiency evaluation step 782 is an algorithm that detects the smallest r from all the code functions 500.

Then, the code efficiency evaluation program 102 compares r with the current R. If r is smaller than R, the code efficiency evaluation program 102 updates r by the optimal code efficiency R (C400—YES, S403). Further, the code efficiency evaluation program 102 determines that the code function 500 is the optimal code function (not shown) (S404). Then, the code efficiency evaluation program 102 compares the counter i with the number n of the code function 500 of the server apparatus 2. If the counter i is not equal to the number n of the code function 500, namely, if the comparison of all the code functions 500 has not been completed, the code efficiency evaluation program 102 increments the counter i, and calculates the code efficiency r of the next code function 500 Om (i+1) (C401—NO, S405).

When the code efficiency calculation of all the code functions 500 has been completed, the code efficiency evaluation program 102 ends the code efficiency evaluation step 782 and outputs the optimal code function (S406).

The code efficiency evaluation program 102 updates the recode corresponding to the current state in the code function management table 300 managed by the statistical database 22, to the optimal code function determined in the code efficiency evaluation step 782. Then, the code efficiency evaluation program 102 transmits the operational log 42 to the application state determination program 100.

### <Operation of the Application State Determination Program 100>

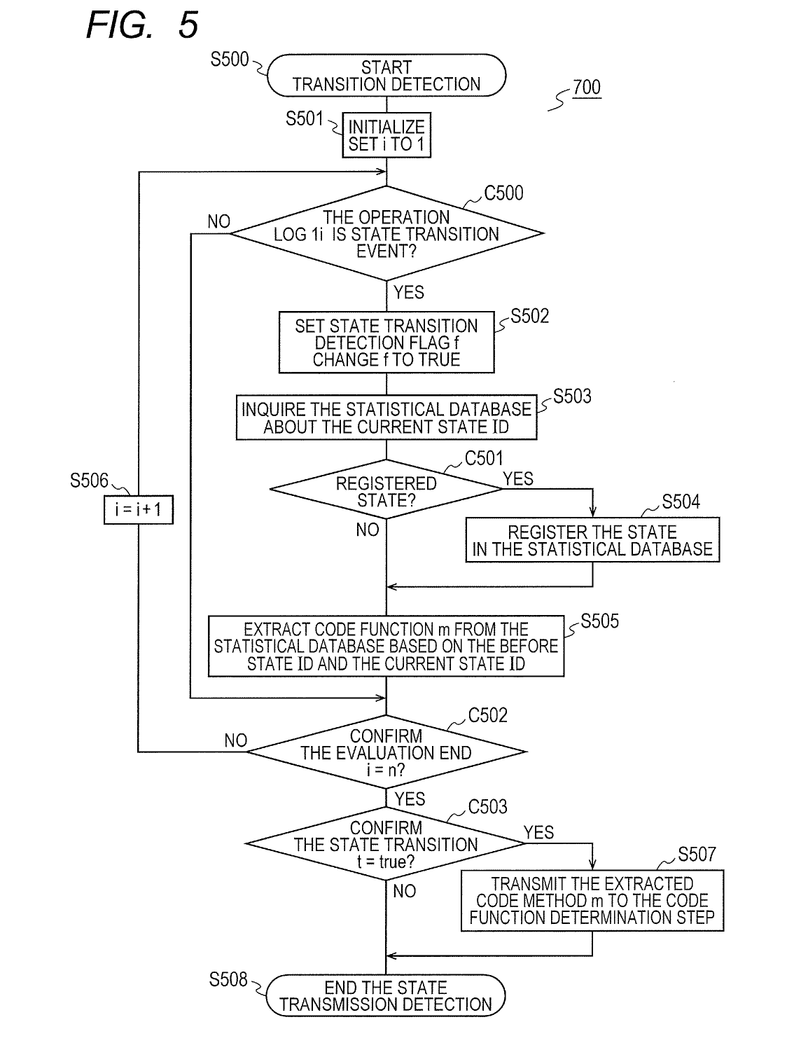

In the state transition detection step 700, the application state determination program 100 shown in FIG. 3 first scans the received operational log 42 to detect whether the state of the target application is changed. If the target application has been changed, the application state determination program 100 outputs a pair 48 of the before state and the current state. The state transition detection step 700 will be described with reference to FIG. 5.

FIG. 5 is an implementation example of the state transition detection step 700 of the target application 110. In this figure, the application state determination program 100 first initializes the counter i by 1 (S501). The counter is a counter used in referring to each of the logs included in the operational log 42. The domain is from 1 to n.

The state transition detection step 700 detects whether the operational log 42 referred to by the counter i is a state transition event (C500). The state transition event is, for example, a change in the check state of a check box and the like of the application. If the application has an ID on the screen, the state transition event is a change in the ID. In the application and the like, the URL is treated as the ID. In this case, a change in the URL or a page transition is the state transition event. When a state transition event is detected, the state transition detection step 700 first sets a flag that indicates that the state transition event is detected (C500—YES, S502). In other words, when the target application is a Web application, the page transition is the state transition.

Then, the state transition detection step 700 queries the application state management table 302 of the statistical database 22 about the operational log 42, and acquires the current state ID (S503). If the state is an unknown state that has never appeared, the state transition detection step 700 newly registers the state in the statistical database 22, and acquires the ID assigned to the particular state (C501—NO, S504).

Then, the state transition detection step 700 holds the current state ID stored in the session management area 600 as the before state ID. Also, the state transition detection step 700 stores the current state ID that is acquired from the statistical database 22, in the session management area 600 as the new current state ID (S505). The above operation is performed for all the operational logs 42. If the state transition detection flag is set at the time when the operation for all the operational logs 42 is completed, the state transition detection step 700 transmits the current state ID and the before state ID that are acquired in the above steps, to a code function determination step 702. Then the state transition detection step 700 ends (C503—YES, 5507, S508).

Returning to the description of the optimal code generation mechanism 900 shown in FIG. 3, the code function determination step 702 of the application state determination program 100 queries the code function management table 300 of the statistical database 22 about the received current state ID and the received before-state ID 48. Then, the code function determination step 702 extracts the code function. Then, the code function determination step 702 transmits the extracted code function 46 to the code table generation program 104 to notify about the change of the code function.

However, at this time, if the communication load reduction may not be expected by exchanging the code table in the configuration in which it is possible to detect that the communication load reduction by the change in the code efficiency is greater than the communication load by the code table transmission from the code efficiency of the code function that has been used in the before state ID and the code efficiency of the code function that should be used in the current state ID, the code function determination step 702 may not notify about the change of the code function. When the analysis of the operational log 42 is completed, the operational log 42 is stored in the operational log database 20.

As shown in FIG. 3, upon receiving the code function change notification, the code table generation program 104 generates the code table 40 by referring to the operation occurrence posterior probability record table 306, the sequence occurrence posterior probability table 308, and the sequence management table 304 in the statistical database 22, as well as the changed code function in the code amount calculation step 740.

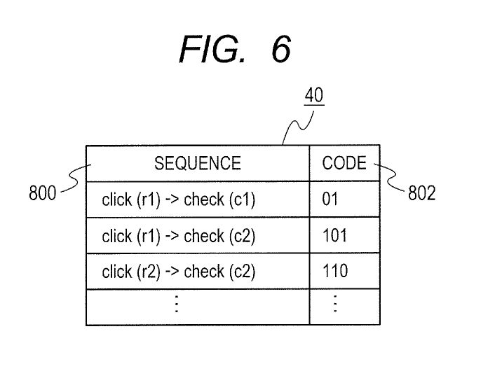

FIG. 6 is an example of the code table 40 generated by the code table generation program 104. The code table 40 is a table in which a plurality of processes corresponds to a single unique code. In this embodiment, the binary code is assigned, but other type of code can also be used as long as the code uniquely corresponds to the sequence.

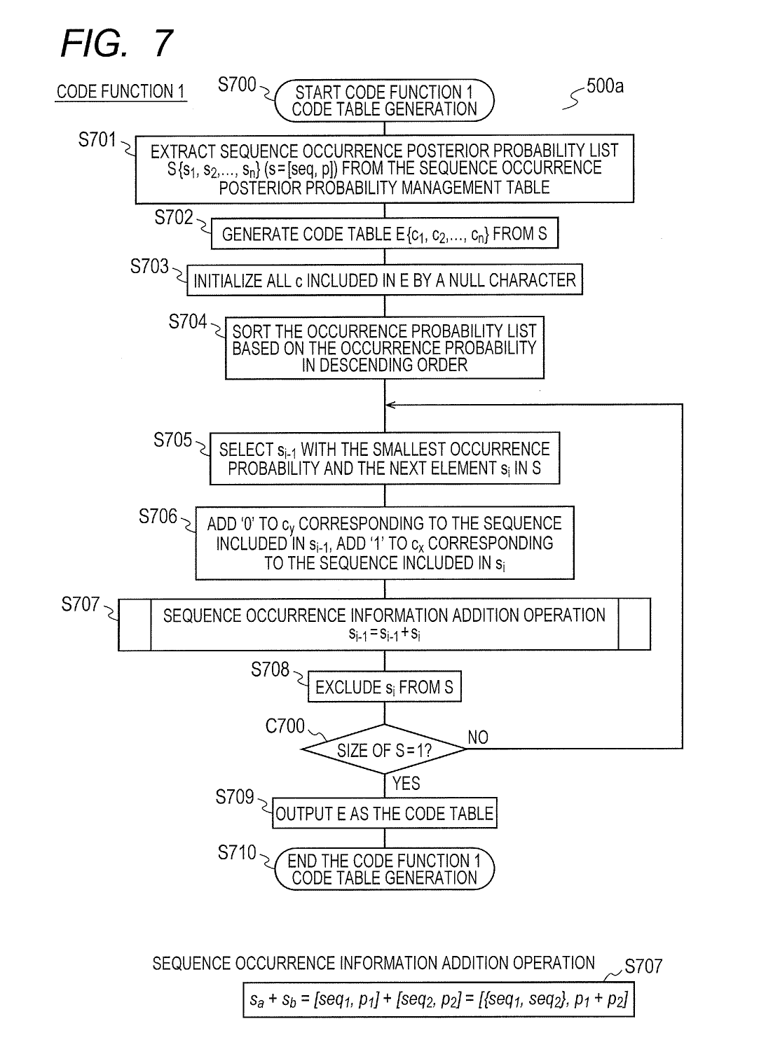

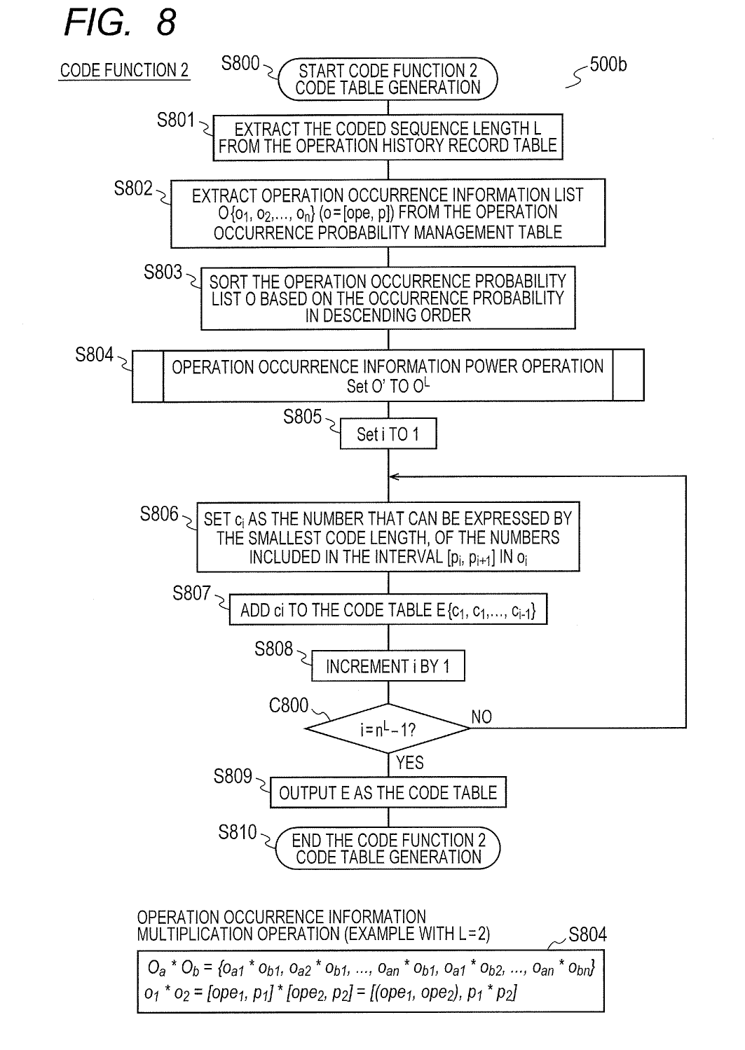

Here, the algorithm of the code function for generating the code table will be described with reference to FIGS. 7 and 8. FIG. 7 is an example of the code function, which is generally called Huffman code. FIG. 8 is a variety of the code function generally called Range Coder, which is different from the original Range Coder in that the generation of the code is stopped at a given sequence length.

In the algorithm of the code function shown in FIG. 7, the code table generation program 104 first refers to the sequence occurrence posterior probability table of the statistical database 22, and extracts the occurrence posterior probability list S in the current state (S701). The occurrence posterior probability list S is a set of pairs s of the sequence and its occurrence probability.

Then, the code table generation program 104 generates a code table 40E of the same size as S (S702). The code table 40E is a set of pairs c of the sequence and the corresponding code.

First, the code table generation program 104 initializes the codes corresponding to all the sequences by a null character (S703). Then, the code table generation program 104 sorts the occurrence posterior probability list S based on its occurrence probability in descending order (S704).

Here is the generation procedure of the code table 40. First, the code table generation program 104 selects s(i−1) with the smallest occurrence probability, as well as the next element s(i) (which is not the element with the next smallest occurrence probability) on the list (S705). Because the list S is sorted in descending order in the initial state, the first element s(0) and the next element s(1) are selected. Then, the code table generation program 104 adds ‘0’ to the code c in E corresponding to the sequence included in s(i−1), and adds ‘1’ to the code c in E corresponding to the sequence included in s(i), respectively (S706)

Here the sequence occurrence information addition operation S707 will be described in order to clarify the meaning of the expression “sequence included in s”. In the addition of two s, the sequence of s is added as a set while the occurrence probability of s is added as the number.

In other words, if

s(a)=({Sequence A},0.1)

s(b)=({Sequence B},0.05)

the addition operation s(a)+s(b) is given by:

s(a)+s(b)=({Sequence A,Sequence B},0.15)

At this time, the “sequences included in s(a)+s(b)” are the sequence A and the sequence B. Thus, the code table generation program 104 performs the operation for each of the codes corresponding to the sequence A and the sequence B in the code table 40E.

Returning to the description of the code function 1 (500a), the code table generation program 104 gives ‘0’ to the code corresponding to the sequence included in s(i−1), and ‘1’ to the code corresponding to the sequence included in s(i). Then, the code table generation program 104 adds s(i) to s(i−1) by the sequence occurrence information addition operation (S707).

Then, the code table generation program 104 excludes s(i) from the occurrence posterior probability list S (S708). Because of this operation, the size of S is reduced by 1. This operation is repeated until the size of S is 1 (C700).

Then, the code table generation program 104 finally outputs the code table 40E, in which the Huffman code is assigned to each sequence. Thus, the generation of the code table by the code function 1 (500a) is completed (S709, S710).

Next, the code table generation by a code function 2 (500b) will be described with reference to FIG. 8. As described above, FIG. 8 is a variety of the code function 500 generally called Range Coder, which is different from the original Range Coder in that the generation of the code is stopped at a given sequence length.

First, the code table generation program 104 refers to the code function generation table 300 of the statistical database 22 and extracts the coding sequence length L (S801). Here, L may be a value given by the user. It is also possible that the code efficiency evaluation program 102 evaluates the code efficiency with respect to several coding sequence lengths L to find the most suitable L.

Next, the code table generation program 104 refers to the operation occurrence posterior probability table of the statistical database 22, and extracts the occurrence posterior probability list 0 in the current state (S802). The operation posterior probability list 0 is a set of pairs o of the operation and its occurrence probability.

Then, the code table generation program 104 sorts the operation occurrence posterior probability list 0 based on the occurrence probability in descending order (S803) Then, the code table generation program 104 multiplies the operation occurrence information by L (S804).

This operation will be described. The multiplication operation of O by itself (=square) is the operation of multiplying all o included in O. Each time the operation is executed, the size becomes several times greater than the element included in O. Further, the multiplication operation of o by itself is added as a set while the order of the operation is maintained, and the occurrence probability thereof is multiplied as the number.

In other words, the code table generation program 104 then generates the code table 40E of the same size as S. The code table 40E is a set of pairs c of the sequence and the corresponding code.

First, the code table generation program 104 initializes the codes corresponding to all the sequences by a null character.

### Here, if

o(a)=({Operation A,Operation B},0.1)

o(b)=({Operation C},0.05)

the multiplication operation o(a)*o(b) is given by:

o(a)*o(b)=({Operation A,Operation B,Operation C},0.005)

Here, it is to be noted that ({Operation A, Operation B, Operation C}, 0.005)≠({Operation A, Operation B, Operation C}, 0.005) with different o.

The operations having this order means the sequence, and the multiplication of the operation occurrence information by L is the operation for calculating the occurrence probability of the sequence of the possible length L, under the assumption that the occurrence probability of all the operations in a certain state is an independent probability.

Returning to the description of the code function 2 (500b), the code table generation program 104 sets c(i) as the number that can be expressed by the smallest code length of arbitrary numbers included in the accumulated occurrence probability P(i+1) from the occurrence probability p(i) to the next element o(i+1) with respect to the all o(i) included in O multiplied by L.

For example, if

o(i)=({Operation A,Operation B,Operation C},0.2)

o(i+1)=({Operation A,Operation B,Operation C},0.1)

the interval [p(i), P(i+1)] is [0.2, 0.3], in which the number that can be expressed by the smallest code length is 0.25=0.01 (binary). In this method, all the codes can be represented by a decimal fraction, so that the valid number after the decimal point ‘01’ is assigned as the code corresponding to the sequence (Operation A, Operation B, Operation C).

When the above operation is performed for all o, the code is assigned to all the sequences of the possible length L in the current state, and thus the code table is completed (C800, S809, S810).

Although mentioned in the description of the code function 2 (500b), the code function 2 (500b) is the code function under the assumption that all the operations that occur are independent in the state. Thus, for the applications and use cases in line with the assumption, it is known that in general the code function 2 (500b) is more efficient in coding than the code function 1 (500a). On the other hand, for example, when the code function 2 (500b) includes many restrictions such as “the operation A and the operation B are exclusive” or when the sequence occurrence probability list S is enormous, the code efficiency of the code function 1 (500a) approaches the code efficiency of the code function 2 (500b), or the code efficiency of the code function 1 (500a) is improved.

The principle of this embodiment is that the analysis of the actual target application 110 is not enough for this use case, and that detection may not be achieved unless it is acquired from the actual operation and evaluated.

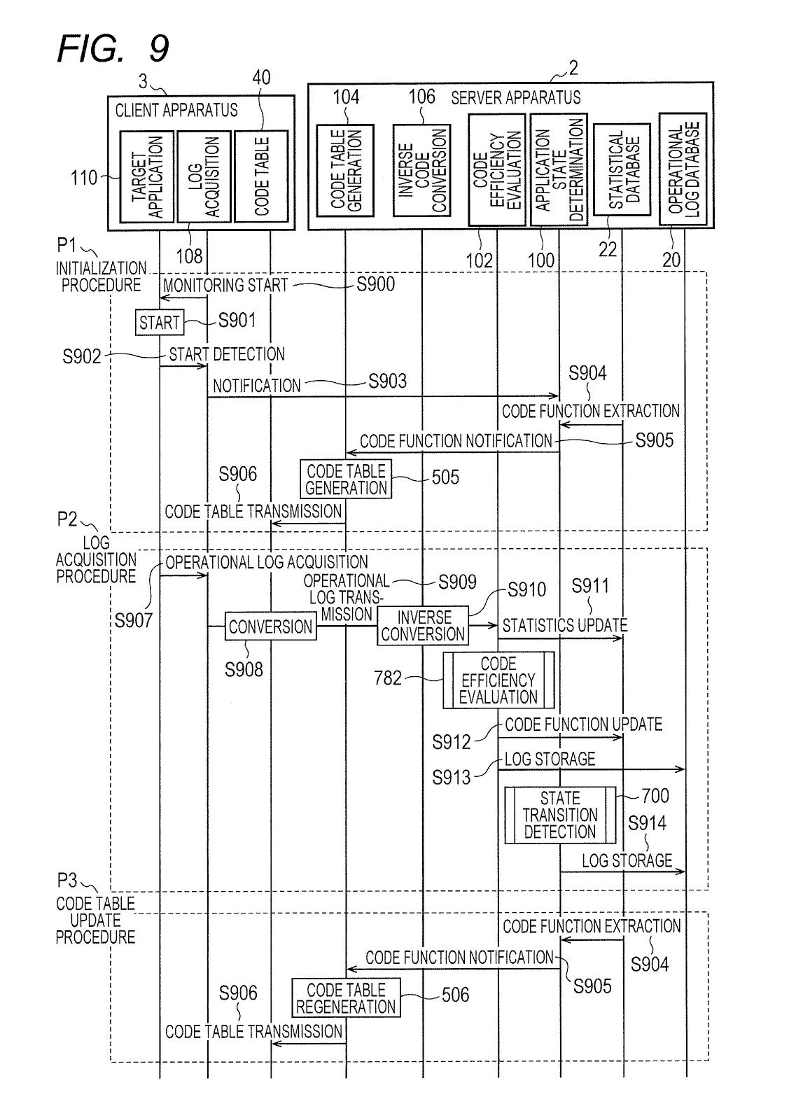

As described above, in this embodiment, the code table is generated by selecting the optimal code function from the statistics of the operational log. Hereinafter, the overall operation of the operational log record system 1 according to the first embodiment will be described with reference to FIG. 9.

FIG. 9 is an example of the operation of the operational log record system 1. In this figure, P1 represents the initialization procedure, P2 represents the log acquisition procedure, and P3 represents the code table update procedure.

### <Process of the Initialization Procedure P1>

First, the operational log acquisition program 108 of the client apparatus 3 starts monitoring the target application 110 (S900). Next, when the target application 110 is started by the user in the client apparatus 3, the operational log acquisition program 108 detects the start of the target application 110 (S901, S902).

The operational log acquisition program 108 extracts the initial state and notifies the server apparatus 2 of the extracted initial state (S903).

The initial state information transmitted to the server apparatus 2 is received by the application state determination program 100. Then, the application state determination program 100 queries the statistical database 22 to extract the code function to be used. At this time, the before state is set to “NO STATE”. Then, the application state determination program 100 notifies the code table generation program 104 of the extracted code function (S904, S905).

The code table generation program 104 generates a code table (505) according to the notified code table method 500, and transmits the code table to the client apparatus 3 (S906). By the initialization procedure described above, the operational log acquisition program 108 is ready to acquire, code, and transmit the operational log. Next, the procedure for acquiring the log and transmitting the log to the server apparatus 2 will be described.

### <Process of the Log Acquisition Procedure P2>

Next, the log acquisition sequence after the completion of the initialization procedure will be described. Every time an operation of the target application 110 by the user occurs or an event occurs on the application in the client apparatus 3, the operational log acquisition program 108 acquires an operational log (S907). The operational log acquisition program 108 codes the acquired operational log by referring to the previously received code table (S908). Then, the operational log acquisition program 108 transmits the coded operational log to the server apparatus 2 (S909). The transmission timing is as follows. The coded operational log is transmitted when the information amount of the coded operational log exceeds a predetermined threshold in the operational log area 602 of the client apparatus 3, or each time the coding is successful. If the operational log area 602 of the client apparatus 3 has enough capacity, it is also possible to transmit the coded operational log at the time when a state transition occurs.

The inverse code conversion program 106 on the server apparatus 2 receives the log from the client apparatus 3, inversely converts the coded log 42e by referring to the code table stored in the session management area 600, and generates the original operational log 42 (S910). Then, the operational log 42 is transmitted to the code efficiency evaluation program 102.

The code efficiency evaluation program 102 evaluates the code efficiency that should be applied to the operational log 42. First, the code efficiency evaluation program 102 calculates the statistics of the operational log 42 and updates the statistical database 22 (S911). Next, the code efficiency evaluation program 102 calculates the code efficiency for the use of each code function by referring to the code functions 500, and determines the most efficient code function. Then, the code efficiency evaluation program 102 updates the statistical database 22 (787, S912).

Next, the operational log 42 is transmitted to the application state determination program. The application state determination program determines the state of the application based on the operational log 42, and detects whether the state has been changed from the before state (S913, 700). Further, the application state determination program stores the operational log 42 in the operational log database 20 (S914).

By the procedure described above, it is possible to code the operational log on the client apparatus 3, inversely code and optimize the coded operational log on the server apparatus 2, and store the operational log. Hereinafter, the procedure for updating the updated code function on the client apparatus will be described.

### <Process of the Code Table Update Procedure P3>

In the operational log acquisition procedure P2, when a change in the state of the target application 110 is detected, the code table update procedure P3 is called. In this procedure, first the application state determination program 100 queries the statistical database 22 about the before state and the current state, and extracts the corresponding code function. Then, the application state determination program 100 notifies the code table generation program 104 of the code function (S904, S905). The code table generation program 104 regenerates the code table (506) and transmits the code table to the client apparatus 3 (S906).

In this embodiment, the above procedure updates the code table at the time when the application state transition occurs. However, in the application that requires more suitable code efficiency, the code table can be changed each time the code function with the highest code efficiency is changed, or when another event occurs.

As described above in detail, with the operational log record system according to the first embodiment, it is possible to reduce the network load between the server apparatus and the client apparatus with the code efficiency suitable for the state of the target application.

### Second Embodiment

In the first embodiment, the target application 110 is stored in the client apparatus 3 in advance. However, in a Web application and the like, there may also be the case where the target application 110 is present on the side of the server apparatus 3, and the server apparatus 2 transmits the target application 110 in response to the request for the application process program included in the client apparatus 3. Such an aspect will be described as a second embodiment below.

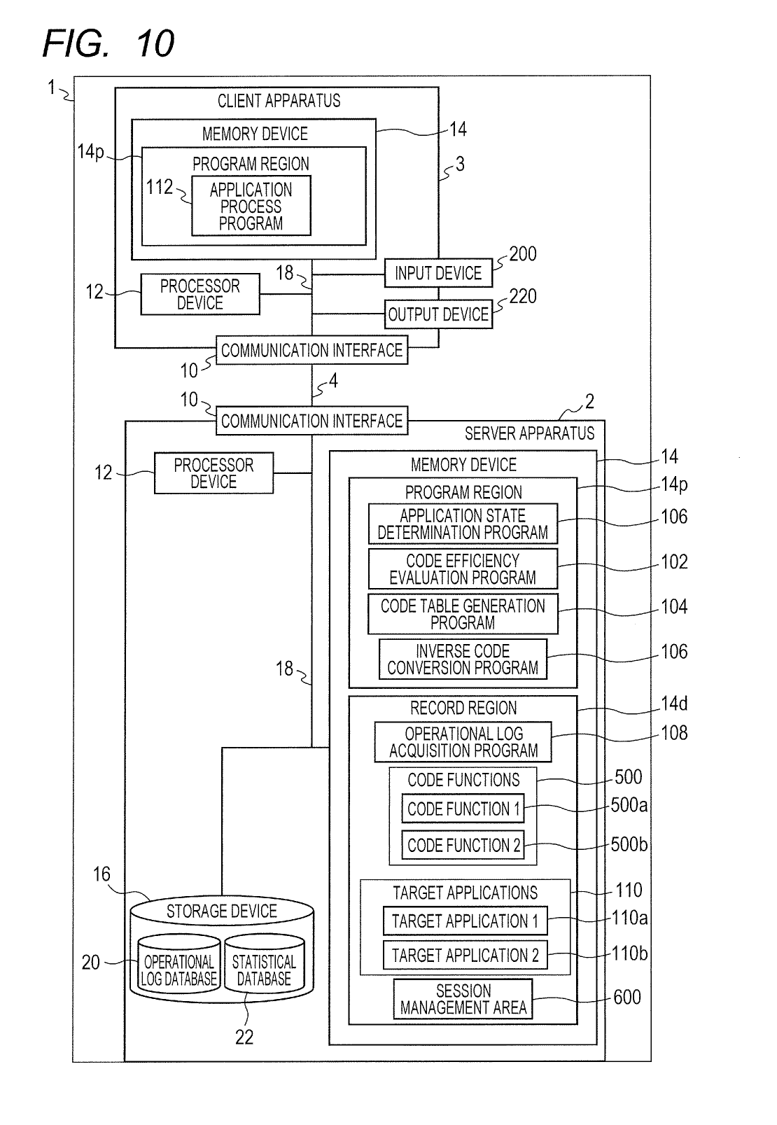

FIG. 10 is a block diagram of an example of the operational log record system 1 according to the second embodiment, in which the target application 110 is transmitted to the server apparatus 2.

In this figure, the operational log record system 1 includes the server apparatus 2 for storing the target application 110 of an operational log and the operational log, as well as the client apparatus 3 for processing the operational log acquisition target application 110. In this embodiment, the device configuration of the server apparatus 2 and the client apparatus 3 is the same as the example shown in FIG. 1 in the first embodiment.

In other words, in the program region 14p of the server apparatus 2, the following programs are located: the application state determination program 100 for determining the state of the operational log acquisition target application 110 based on the operational log transmitted from the client apparatus 3; the code efficiency evaluation program 102 for evaluating the code efficiency of the operational log; the specified code function 500; the code table generation program 104 for generating a code table based on the sequence occurrence frequency; and the inverse code conversion program 106 for inversely converting the coded operational log based on the code table. In this embodiment also, two or more code functions 500 are stored in the record region 14d.

Further, in the record region 14d of the server apparatus according to this embodiment, the following programs are located: the program for the operational log acquisition target application 110 for acquiring the operational log; and the operational log acquisition program 108 for monitoring the target application 110, acquiring the operational log of the application, coding the acquired log, and transmitting the coded log to the server apparatus 2. In this embodiment, when a request is made from the client apparatus 3 to the server apparatus 2, these programs are transmitted to the client side and used. Note that the storage device 16 as well as the databases 20 and 22 stored in the storage device 16 are the same as those in the first embodiment.

Further, in this embodiment, the program region 14p in the memory device 14 of the client apparatus 3 includes the application process program 112 for requesting the operational log acquisition target application 110 of the server apparatus 2.

The application process program 112 is a program for reading and running another target application 110, and more specifically, is a Web browser and the like. Taking the Web browser as an example, the program acquires a Web page described in Hyper Text Markup Language (HTML) or JavaScript (Java is a registered trademark) according to the protocol such as Hyper Text Transfer Protocol (HTTP), visualizing the Web page by using the rendering engine and script engine of the Web browser, and providing the Web page to the user. The feature of this program is that the behavior varies depending on the read target application 110 even if the application process program itself is not changed. This embodiment is designed to acquire the operational log 42 on the client apparatus 3 by transmitting the target application 110 in which the operational log acquisition program 108 and the code table 40 are embedded. This will described below.

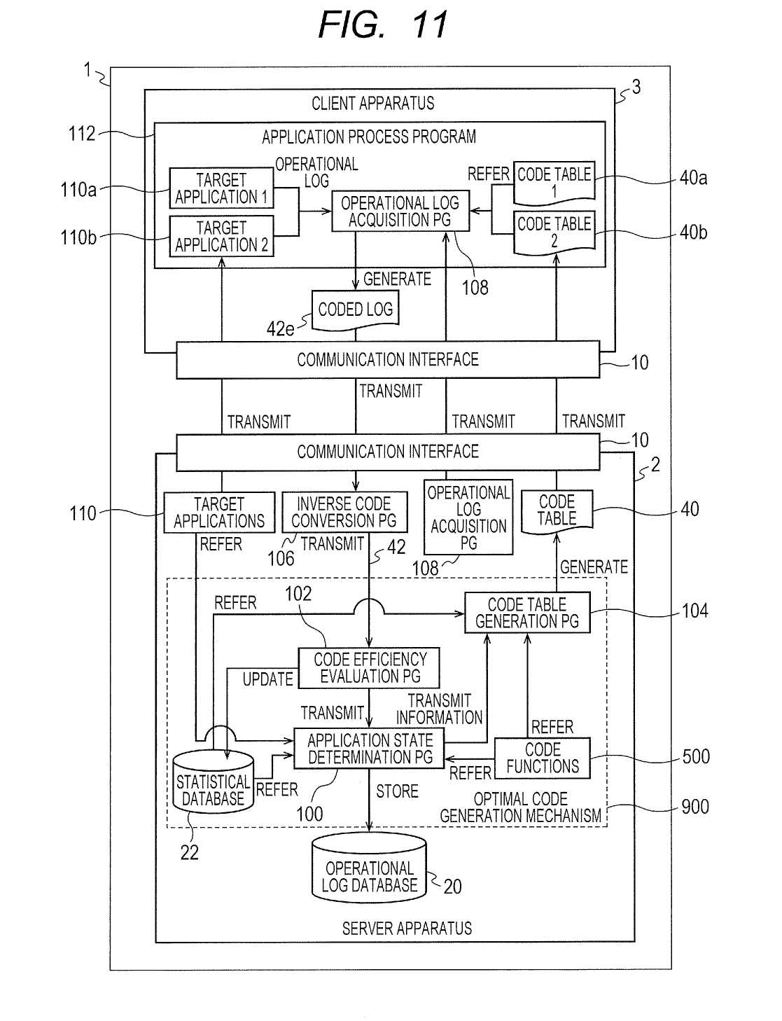

The system configuration described above with reference to FIG. 10 shows the initial state, so that there is no devices present on the memory device 14 of the client apparatus 3, except the application process program. Hereinafter, the application process program will be descripted with reference to FIG. 11, showing the path from the acquisition of the operational log to the storage thereof after the request for the target application 110 is made to the server apparatus 2.

FIG. 11 is an example of the path from the acquisition of the operational log 42 to the storage of the operational log 42 in the operational log record system 1 according to the second embodiment.

First, the application process program 112 on the client apparatus 3 requests the server apparatus 2 to acquire the target application 110.

Upon receiving the acquisition request, the server apparatus 2 embeds the operational log acquisition program 108 as well as the code table 40 generated by the code function suitable for the initial state of the target application 110, into the corresponding target application 110 of the target applications 110. Then, the server 2 transmits the particular target application 110. The application process program 112 receives the target application 110 in which the operational log acquisition program 108 and the code table 40 are embedded, from the server 2. The target application 110 is stored in the memory managed by the application process program 112, and starts running within the application process program 112.

Then, the user operation to the application process program 112 is as follows. The operation of the target applications 110a, 110b, which are loaded into the memory device 14 of the client apparatus 3, is acquired by the operational log acquisition program 108 loaded into the memory device 14 on the client apparatus 3. Then, the operational log is coded based on the code tables 40a and 40b corresponding to the applications 110a and 110b, respectively. Then, the coded operational log is transmitted to the server apparatus 2 through the communication interface 10.

The generated and transmitted coded log 42e is received by the inverse code conversion program 106 of the server apparatus 2. The inverse code conversion program 106 inversely converts the coded log 42e into the operational log 42 by referring to the code table 40. Then, the inverse code conversion program 106 transmits the inversely converted operational log 42 to the optimal code generation mechanism 900.

The code efficiency evaluation program 102 of the optimal code generation mechanism 900 evaluates the code efficiency when each code function acquired by referring to the code functions 500 is applied to the received operational log 42. Further, the code efficiency evaluation program 102 extracts the statistics from the operational log 42 and updates the corresponding tables of the statistic database 22. Then, the code efficiency evaluation program 102 transmits the operational log 42 to the application state determination program 100.

The application state determination program 100 determines the change in the application state from the event history included in the operational log 42. If the application state has been changed, the application state determination program 100 extracts the suitable code function from the statistical database 22, and notifies the code table generation program 104. Upon receiving the notification, the code table generation program 104 selects the suitable code function from the code functions 500 if needed, regenerates the code table 40, and transmits the code table 40 to the client apparatus 3. The code table 40 received by the client apparatus 3 is updated in the code table area by the operational log acquisition program 108.

Finally, the application state determination program 100 stores the operational log 42 in the operational log database 20. Thus, the storage of the operational log 42 is completed. The above is the general process from the generation of the operational log 42 to the storage thereof after the request for the target application 110 according to the second embodiment.

In the second embodiment, compared to the first embodiment, all the processes except the embedding of the initial operational log acquisition program 108 and the code table 40 as well as the loading of the target application 110, are exactly the same in the first and second embodiments. This means that the individual programs can be used in the two embodiments, thus showing the versatility of the present invention.

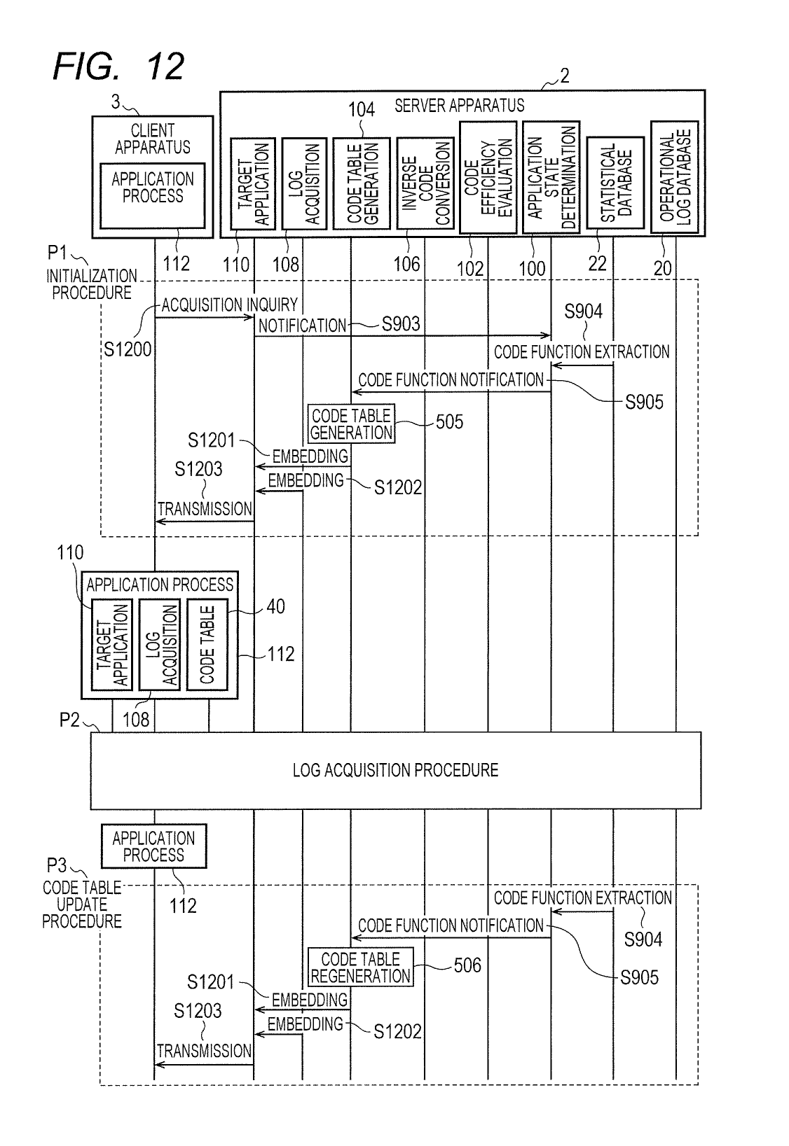

Hereinafter, the process including the embedding of the operational log acquisition program 108 and the code table 40 into the target application 110, which is different from the operation in the first embodiment, will be described with reference to FIG. 12.

FIG. 12 is an example of the operation of the operational log record system 1 according to the second embodiment.

### <Process of the Initialization Procedure P1>

First, the application process program 112 of the client apparatus 3 requests the server apparatus 2 to acquire the log acquisition target application in the target applications 110 of the server apparatus 2 (S1200). Upon receiving the request, the target application notifies the application state determination program 112. The application state determination program 112 receives the notification, and detects the state of the target application based on the notification. Then, the application state determination program 112 quires the statistical database 22 about the current state to extract the code function suitable for the current state, and notifies the code table generation program 104 of the code function (S903, S904, and S905).

The code table generation program 104 generates the code table 40 (505) according to the notified code function, and embeds the code table 40 into the target application 110 (S1201). Further, the code table generation program 104 also embeds the operational log acquisition program 108 into the target application 110, and transmits the target application 110 to the client apparatus 3 (S1202, S1203).

By the procedure described above, the state of the program running on the client apparatus 3 and on the server apparatus 2 is equal to the example in the first embodiment. For this reason, it is possible to perform the log acquisition procedure by the target application 110, the operational log acquisition program 108, and the code table 40, which are transmitted to the client apparatus 3, in the same way as the log acquisition procedure P2 shown in FIG. 7 according to the first embodiment.

Hereinafter, the update procedure P3 of the code table 40 will be described.

### <Process of the Code Table Updater Procedure P3>

In this embodiment, it is assumed that the acquisition request for the target application 110 is made again to the server apparatus 2 in the state transition of the target application 110. If such a method is not performed in the state transition, the code table 40 is updated by the same method as in the first embodiment.

In the process of the log acquisition procedure P2, when detecting the state transition, the application state determination program 100 quires the statistical database 22 about the before state and the current state, and extracts the corresponding code function 500 (S904). Then, the application state determination program 100 notifies the code table generation program 104 of the extracted code function (S905).

The code table generation program 104 regenerates the code table 40 (506) according to the notified code function. Next, the server apparatus 2 transmits the target application 110 in which the generated code table 40 and the operational log acquisition program 108 are embedded, to the client apparatus 3, and thus the log acquisition is possible (S1201, S1202, S1203).

By the procedure described above, also in the second embodiment, it is possible to store the operational log by the same operation as in the first embodiment with low communication load. Further, low client load can be achieved by storing the target applications on the side of the server apparatus.

### INDUSTRIAL APPLICABILITY

The present invention is useful for the acquisition of the operational log of the application, and the reduction of the communication load between devices constituting the record system.

### REFERENCE SINGS LIST

1. Operational log record system
2. Server apparatus
3. Client apparatus
4. Network connectivity
10. Communication interface
12. Processor device
14. Memory device
16. Storage device
18. Bus
20. Operational log database
22. Statistical apparatus
40. Code table
42. Operational log
200. Input device
220. Output device
500. Code functions
900. Optimal code generation mechanism

1. An operational log record system comprising:
a client apparatus for acquiring an operational log; and
a server apparatus for storing the operational log,
wherein each of the client apparatus and the server apparatus includes a storage unit for storing a program and data, a processing unit for processing the program, and a communication interface,
wherein the storage unit of the server apparatus stores the operational log transmitted from the client apparatus through the communication interface, a plurality of code functions for coding the operational log, and a code table generation program for estimating the state of the program to be processed on the client apparatus based on the received operational log and for generating a code table based on the estimated program state,
wherein the storage unit of the client apparatus stores the code table transmitted from the server apparatus, a target application as the program, an operational log acquisition program for acquiring the operational log for the target application, and a code conversion program for coding the operational log acquired by the operational log acquisition program based on the code table received from the server apparatus,
wherein the processing unit of the client apparatus transmits the operational log coded by the code conversion program, to the server apparatus,
wherein the processing unit of the server apparatus stores the received operational log in the storage unit of the server apparatus.

2. The operational log record system according to claim 1,
wherein the target application is transmitted to the client apparatus from the server apparatus.

3. The operational log record system according to claim 1,
wherein the storage unit of the server apparatus stores a program state estimation program for estimating the program state of the program processed on the client apparatus based on the operational log,
wherein the processing unit of the server apparatus estimates the program state by executing the program state estimation program.

4. The operational log record system according to claim 1,
wherein the storage unit of the server apparatus stores a code efficiency evaluation program for evaluating the code efficiency of the operational log,
wherein the processing unit of the server apparatus evaluates the efficiency of the code function by executing the code efficiency evaluation program, and generates the code table by using the evaluation result in the execution of the code table generation program.

5. The operational log record system according to claim 1,
wherein the target application as the program is a Web application,
wherein the processing unit of the server apparatus generates the code table by executing the code table generation program in the page transition of the Web application that shows the transition of the program state.

6. The operational log record system according to claim 1,
wherein the storage unit of the server apparatus includes an inverse code conversion program for inversely converting the coded operational log transmitted from the client apparatus,
wherein the processing unit of the server apparatus inversely converts the received coded operational log by executing the inverse code conversion program.

7. A server apparatus for collecting and storing an operational log acquired by a client apparatus,
wherein the server apparatus comprises a storage unit for storing a program and data, a processing unit for processing the program, and a communication interface,
wherein the storage unit stores the operational log transmitted from the client apparatus through the communication interface, a plurality of code functions for coding the operational log, a code table generation program for estimating the state of the program to be processed on the client apparatus based on the operational log and for generating a code table based on the estimated program state, and a target application for collecting the operational log by the client apparatus,
wherein the processing unit estimates the state of the program to be processed on the client apparatus based on the operational log, generates a code table by selecting one of the plurality of code functions based on the estimated program state, transmits the code table to the client apparatus, and sequentially stores the operational log received from the client apparatus.

8. The server apparatus according to claim 7,
wherein the processing unit transmits the target application stored in the storage unit, to the client apparatus in response to an acquisition request from the client apparatus.

9. The server apparatus according to claim 8,
wherein when the target application acquisition request is received from the client apparatus, the processing unit extracts the code function suitable for the program state of the target application.

10. The server apparatus according to claim 8,
wherein when the target application acquisition request is received from the client apparatus, the processing unit extracts the code function according to the program state of the target application, generates the code table based on the extracted code function, and embeds the generated code table into the target application that is then transmitted to the client apparatus.

11. The server apparatus according to claim 8,
wherein the storage unit of the server apparatus stores a program state estimation program for estimating the program state of the program processed on the client apparatus based on the operational log,
wherein the processing unit of the server apparatus estimates the program state by executing the program state estimation program.

12. The server apparatus according to claim 8,
wherein the storage unit of the server apparatus stores a code efficiency evaluation program for evaluating the code efficiency of the operational log,
wherein the processing unit of the server apparatus evaluates the efficiency of the code function by executing the code efficiency evaluation program, and generates the code table by using the evaluation result in the execution of the code table generation program.

13. An operational log storage program executed by a processing unit of a server,
wherein the server includes a storage unit for storing a program and data as well as the processing unit for processing the program, to collect and store the operational log of the program acquired by a client,
wherein the operational log storage program allows the processing unit to perform the steps of:
receiving the operational log transmitted from the client apparatus through the communication interface;
estimating the state of the program to be processed on the client apparatus based on the received operational log;
generating a code table for coding the operational log based on the estimated program state;
transmitting the generated code table to the client apparatus; and
sequentially storing the received operational log.

14. The operational log storage program according to claim 13,
wherein when the program for collecting the operational log by the client apparatus is a Web application, the operational log storage program allows the processing unit to generate the code table in the page transition of the Web application.

15. The operational log storage program according to claim 13,
wherein the operational log storage program allows the processing unit to perform the steps of:
extracting the code function suitable for the target application when the acquisition request for the target application, which is the program for collecting the operational log, is received from the client apparatus;
generating the code table based on the extracted code function; and
embedding the code table into the target application that is then transmitted to the client apparatus.
